(19) United States
(12) Patent Application Publication
(10) Pub. No.: US 2008/0256256 A1
(43) Pub. Date: Oct. 16, 2008

(54) Method and Apparatus for Autonomically Regulating Ratio of Stateful to Stateless Transaction Processing for Increasing Scalability in a Network of SIP Servers

(75) Inventors: Arup Acharya, Nanuet, NY (US); Vijay A. Balasubramaniyan, Atlanta, GA (US); Mustaque Ahamad, Atlanta, GA (US)

Correspondence Address: GEORGE A. WILLINGHAN, III;AUGUST LAW GROUP, LLC, P.O. BOX 19080, BALTIMORE, MD, 21284-9080, US

(73) Assignee: International Business Machines Corporation, Armonk, NY (US)

(21) Appl. No.: 11/733,221

(22) Filed: Apr. 10, 2007

(51) Int. Cl. G06F 15/173

(52) U.S. Cl. 709/238

(57) ABSTRACT

Systems and methods are provided for maximizing call throughput in a server network by optimizing the balance of stateful to stateless handling or transactions at each server within the network. The identification of transaction messages to be handled statelessly or statefully is made at each proxy server within the network in order to maximize the total throughput at that proxy server within prescribed processor utilization limits. In general, each transaction is handled statefully by at least one server within the network. Reports on the stateful handling of messages and the resource consumption at various proxies are communicated throughout the network to be used in identifying the ratio of messages to be forwarded statefully to messages to be forwarded statelessly at any given proxy.

### FIELD OF THE INVENTION

The present invention relates to session initial protocol based network communications.

### BACKGROUND OF THE INVENTION

A growing class of applications, including voice over internet protocol (VoIP), instant messaging (IM) and Presence, are enabled using Session Initiation Protocol (SIP). A description of SIP is given in J. Rosenberg, H. Schulzrinne, G. Camarillo, A. Johnston, J. Peterson, R. Sparks, M. Handley, and E. Schooler, SIP: Session Initiation Protocol, RFC 3261, June 2002. To support the rich functionality required by these applications, resource consumption at a SIP server varies widely based on request type, state maintained and routing actions. The resource consumption at a SIP server can be experimentally evaluated for different use case scenarios. In general, these experimental evaluations show that maintaining state in the server doubles the processing time per SIP transaction. In this light, statically configuring a SIP server to be either stateful or stateless theoretically results in sub-optimal call throughput.

Estimates predict that by the year 2010, the global number of civilian VoIP users will reach 197.2 million, about 40 times that of the 4.8 million in 2004. In addition, the income generated from VoIP equipment will reach 24.5 billion dollars, three times more than the 8.04 billion dollars in 2004. SIP is the protocol of choice for deploying VoIP. This large anticipated VoIP user base will require an infrastructure that is capable of handling large volumes of call traffic. The SIP server, which is responsible for call establishment and call tear-down, will be directly impacted by this high call load. Therefore, resource needs and potential bottlenecks that could limit the scalability of SIP need to be eliminated.

A representative SIP server can be used to measure the processing resources consumed by call handling functions and, in particular, on the resources required by maintenance of call related state. This call related state is used by a server to maintain context across a set of messages, enabling better message handling or providing richer functionality. In a system containing multiple servers, one serve may choose to not maintain call state, because call state is already maintained by another server within the system. For this reason, a given SIP server can operate in either a stateful or a stateless mode. On a per-call basis, maintaining state, i.e., a stateful server, consumes twice the central processing unit (CPU) resources compared to not maintaining state, i.e., a stateless server. In addition, a stateful server reaches 100% CPU utilization, called saturation, at one fourth the call rate of a stateless server. This increase in processing resources results from the fact that maintaining state leads to CPU utilization increasing quadratically with call rate. The CPU utilization for a stateless server, however, increases linearly.

### SUMMARY OF THE INVENTION

In general, commercial SIP servers are deployed in a hierarchy, offering a degree of flexibility in where the state associated with the transactions of a given call or dialog can be maintained. Systems and methods in accordance with the present invention utilize an arrangement or hierarchy of SIP-based servers in combination with a state distribution algorithm that distributes state across these servers to maximize call throughput. The state distribution algorithm allows each server to decide the amount of state that it maintains locally and therefore achieve close to optimal call throughput. For a simple hierarchy that contains two servers in series, an increase in throughput is accomplished when state distribution is determined dynamically using the state distribution algorithm as opposed to a static server configuration where each server statically decides to operate in either a stateful or stateless mode.

In general, stateful transactions consume more server resources than stateless transactions. Consider a scaling curve of CPU utilization vs. transactions/sec, for stateful transactions and stateless transactions and assume the max transactions/sec that can be handled statefully be T_{SF}, and statelessly be T_{SL} at a single SIP proxy server. For any given load of T tran/sec, T_{SF}<T<T_{SL}, there is an optimum split of T into T_{SF} and T_{SL} (T=T_{SF}+T_{SL}) at each server for a max CPU utilization. Systems and methods in accordance with the present invention provide for the handling of each input transaction, and the plurality of messages that compose each transaction, statefully at least one server within the network. In one embodiment, at the i^{th} proxy, Pᵢ, all the messages, T_{SF} [i] that have been handled statefully at servers earlier than Pᵢ, i.e., P₁, P₂, . . . , Pᵢ₋₁ are taken into account. The remainder of the messages has been handled only statelessly, T_{SL} [i], to this point. T_{SF} [i] messages are forwarded statelessly at Pᵢ, which consumes some fraction of the CPU resource at that server. The remainder of the CPU utilization is used to process as much of the T_{SL} [i] messages statefully as possible, and the balance of T_{SL} [i] will still be forwarded statelessly.

In one exemplary embodiment, the present invention is directed to a method for dynamic maintenance of state in a server network comprising an arrangement of a plurality of servers arranged. In order to process calls or dialogs through the server network, a plurality of transactions is processed by a plurality of proxy servers by routing a plurality of messages through the network. Each call contains a plurality of transactions, and each transaction contains a plurality of messages. Preferably, the transactions are processed using session initial protocol (SIP) although any protocol capable of allowing transactions to be processed either statefully or statelessly can be used.

The ratio of transactions processed statefully to transactions processed statelessly is optimized at each one of the plurality of proxy servers to maximize the total number of messages routed through the network. State is maintained, however, for each one of the plurality of transactions at only one of the plurality of proxy servers in the network. In order to optimize the ratio of stateless to stateful processing, a fraction of the routed messages to be forwarded statefully is identified at each one of the plurality of proxy servers. In one embodiment, in order to identify at each one of the plurality of proxy servers a portion of the routed messages to be forwarded statefully, a proxy server communicates to a downstream proxy server messages already forwarded statefully. This includes the immediately upstream proxy server and all upstream proxy servers in the chain of upstream proxy servers. The remaining messages are forwarded statefully at the proxy server until a pre-defined resource utilization threshold is reached.

The resource utilization by the downstream proxy server is determined based on forwarding the identified portion of the routed messages statefully and a balance of the routed messages statelessly. This resource utilization is compared to a pre-defined utilization threshold for the downstream proxy server. The identified portion is decreased based on the comparison of the determined resource utilization to the pre-defined utilization threshold when the determined resource utilization exceeds the predefined utilization threshold. In addition to initially decreasing the number of statefully forwarded messages, the number of statefully forwarded messages can be further decreased at a later time when the utilization threshold of the downstream server exceeds the pre-defined utilization threshold. In one embodiment, identification of the portion of the messages to be forwarded statefully by the downstream server includes selecting all routed messages not identified as having been forwarded statefully by the upstream proxy server.

Optimization of the ratio of stateless to stateful forwarding of messages occurs at each proxy server within the network and includes the identification at each proxy server of the messages to be forwarded statefully. In order to identify those messages to be forwarded statefully, an identification is made at each proxy server regarding whether or not a given routed message has been already forwarded statefully. If so, then the message can be forwarded statelessly. If not, then additional checks are made to determine if the message should be forwarded statefully. For example, a check is made at each proxy server to identify if the current number of statefully forwarded messages exceeds a prescribed limit for that proxy server. In addition, each proxy server identifies if a given message is part of an existing transaction, or if a given message is a retransmission. In one embodiment, optimization of the ratio of stateless to stateful forwards include forwarding a sufficient number of messages statelessly at each proxy server to provide a sufficient number of messages to be forwarded statefully by downstream proxy servers

In one embodiment, the number of messages forwarded statefully for at least one proxy server is reduced in order to create resource utilization capacity at that proxy server. The status of the various proxy serves is communicated up and down throughout the hierarchy. For example, saturation reports, i.e. throttle and unthrottle messages, are communicated from downstream proxy servers to upstream proxy servers regarding the level of resource utilization saturation at the downstream proxy servers. These saturation reports include an indication that all downstream proxy servers are saturated. In addition, state summaries are communicated from upstream proxy servers to downstream proxy servers identifying routed messages that have already been forwarded statefully. In addition to optimizing the ratio of stateless to stateful forwarding at each proxy server in order to maximize call throughput, the portion of messages routed statefully at each proxy sever is balanced substantially evenly across all proxy servers.

### BRIEF DESCRIPTION OF THE DRAWINGS

FIG. 1 is a schematic representation of a call setup architecture for use with embodiments of the present invention;

FIG. 2 is a schematic representation of a dialog between two users across a network; and

FIG. 3 is a schematic representation of dynamic and static state maintenance for a two server arrangement.

### DETAILED DESCRIPTION

Session Initiation Protocol (SIP) is a control plane protocol used in connection setup and teardown for a variety of applications including Voice over Internet Protocol (VoIP) communications, Instant Messaging Services (IMS), Presence and the Third Generation Partnership Project (3GPP). A description of Presence is found in J. Rosenberg, A Presence Event Package for the Session Initiation Protocol (SIP), RFC 3856, August 2004, and a description of 3GPP is found in The 3rd Generation Partnership Project (3GPP), http://www.3gpp.org. A description of IM is found in Gonzalo Camarillo and Miquel-Angel Garcia-Martin, The 3G IP Multimedia Subsystem (IMS): Merging the Internet and the Cellular Worlds, John Wiley & Sons, ISBN 0-470-01818-6 (2006). For a given pair of users to communicate using SIP, each member of the pair needs to know the other member's SIP Universal Resource Indicator (URI). Each URI identifies the user and can be associated with one or more end points within a given system. SIP uses an application overlay containing proxy servers and location services to locate end points.

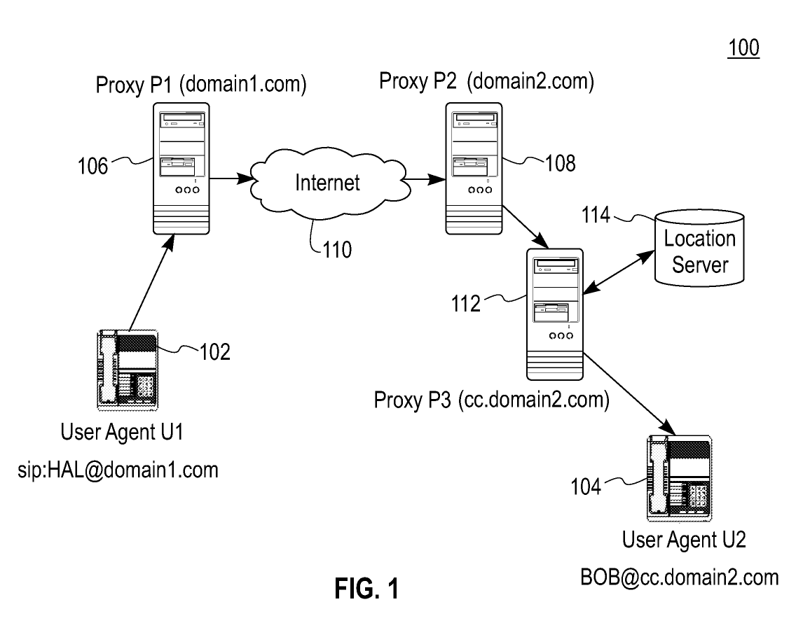

Referring initially to FIG. 1, an exemplary embodiment of a VoIP communication 100 is illustrated. When a first user Hal 102, identified by SIP URI sip:HAL domain1.com, calls a second user Bob 104, sip:bob@cc.domain2.com, the call request message is sent to the proxy server responsible for domain1.com, proxy P1 106. This first proxy P1 determines how to route the call to a second proxy server 108, P2, that is responsible for domain2.com, which is Bob's domain. The call request message is routed to P2 across one or more networks 110. Possible networks include local area networks and wide area networks including the Internet. The second proxy server, P2, 108 is responsible for the top level of domain2.com. Upon receipt of the call request message, P2 identifies an appropriate sublevel domain that houses the call recipient. As illustrated, bob@cc.domain2.com is located in cc.domain2.com, and the call request is routed to a third proxy server 112, P3, that is responsible for this sub level domain. The third proxy server, P3, contacts a database 112, which as illustrated is referred to as a location service, to determine the current internet protocol (IP) address of the phone associated with bob@cc.domain2.com. The third proxy server routes the call setup request to the associated phone, i.e. user agent U2. Having identified and established the call end points, media is routed directly between these two endpoints and does not need to traverse and be processed by the proxy servers.

As illustrated in this exemplary call setup, SIP servers can be organized into a hierarchy containing servers disposed in series or in parallel. Therefore, within a single domain a request may traverse through multiple servers. Exemplary systems and methods in accordance with the present invention utilize this existence of multiple servers within a single domain over which state can be distributed to maximize the volume of calls routed through the domain.

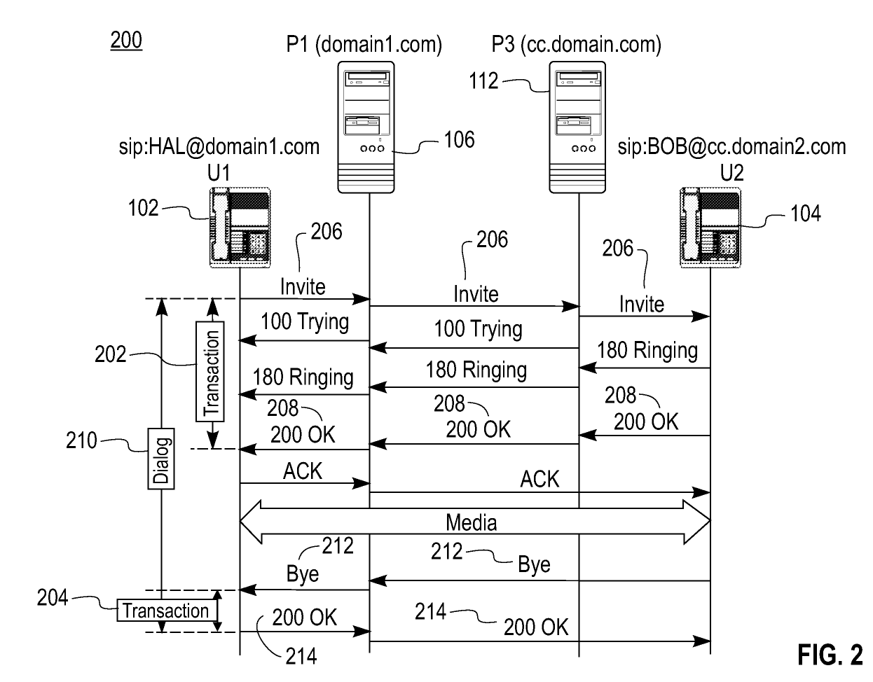

Referring to FIG. 2, an exemplary embodiment of the messages that are exchanged for call setup and call teardown 200 are illustrated. The intermediate hop-by-hop proxy and the location server illustrated with respect to FIG. 1 have been eliminated, for purposes of simplicity. The entire call, which is also referred to as a dialog 210, is constructed from a series of transactions. A given transaction contains a plurality of message. As illustrated, these messages include all messages starting from an initial request through to an associated final response. The dialog 210 includes all transactions that are part of the entire call or dialog. As illustrated, the dialog 210 includes the call setup transaction 202 and the call tear-down transaction 204. The call setup transaction starts with the INVITE message 206 and includes all intermediate messages exchanged until the 200 OK 208 final response. The intermediate messages are provisional responses and are used to indicate progress during the transaction.

A server that maintains state for the duration of a transaction is referred to as a transaction stateful server. The first proxy server 106 (P1) and the third proxy server 112 (P3) are both transaction stateful servers. If a given server maintains state for the length of the entire dialog, that server is dialog stateful. Only the first server P1 is dialog stateful. Therefore, the BYE message 212 and the final 200 OK message 214 will continue to traverse through the first server P1.

By virtue of maintaining state, transaction stateful servers absorb retransmissions, handle forking requests, redirect requests and registrations. Dialog stateful servers are used when state needs to tie down the INVITE transaction to subsequent transactions within the dialog such as a subsequent REINVITE or BYE transaction. An example of the utility of dialog stateful servers is call billing.

Stateless servers maintain no state. One advantage of stateless servers is the ability to process requests very quickly. Most widely used proxy servers can be either stateless or stateful and are statically configured to operate in one of these two modes. The static mode of state configuration, however, is suboptimal. Systems and methods in accordance with the present invention utilize dynamic state maintenance across a plurality of servers within a system to increase call throughput.

Stateful servers by virtue of doing more work than stateless servers will always consume more resources. Exemplary embodiments of systems and methods for increasing scalability in a network of SIP servers in accordance with the present invention utilize this observation by dynamically maintaining the ratio of transactions routed statefully to transactions routed statelessly at each proxy server to optimize call throughput. Within a domain a transaction typically traverses through multiple proxy servers, and this dynamic optimization of stateless to stateful routing is handled at each one of the proxy servers. In a simple embodiment, a request traverses through two servers in series, a first server and a second server, both disposed within a given domain. The possible static configurations for these two servers include both stateful servers, one stateful server and one stateless server and both stateless servers. When both servers are stateful servers, each server by virtue of being stateful maintains state for each transaction that passes through that server. Therefore, the maximum number of transactions that each server is able to service equals the saturation limit of a stateful server, say T_{SF}, because each server sees the same request load.

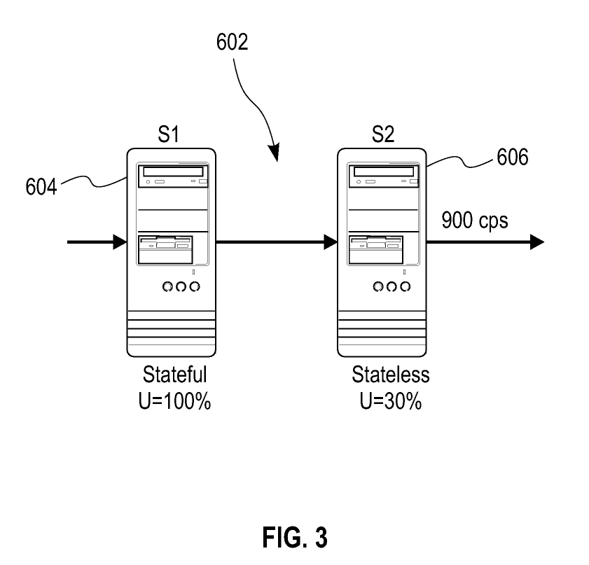

Referring to FIG. 3, in a combined arrangement 602 where one of these servers, S1, is stateful 604 and the other server, S2, is stateless 606, the system continues to have maximum throughput of T_{SF}, because the stateful server is the bottleneck and dictates or limits the overall throughput. Although the system has attained its maximum attainable throughput, the second server, S2, by handling the entire load statelessly will still be under-utilized in this configuration. This under utilization indicates that the maximal throughput limit of this system could be pushed further, because the maximal throughput of the system typically occurs when all server nodes in the system are operating at full utilization.

The reason for this underutilization is that each server statically decides that all requests to it are either to be handled statefully or statelessly, and this decision is not modified or changed. Systems and methods in accordance with the present invention instead employ dynamic state maintenance for the proxy servers in the system. In one embodiment, proxy servers within the system are configured to be either stateful or stateless on a per request or per transaction basis, as opposed to being always stateful or stateless. A given proxy server within the system forwards a fraction of the transactions received by that proxy server statefully and forwards the balance of the received transactions statelessly. If each proxy server adopts a greedy strategy and attempts to forward the entire call load statefully, server saturation will occur when the call load increases to T_{SF}, and the saturated server will become a bottleneck. Therefore, systems and methods in accordance with the present invention utilize a modified greedy strategy, where a given proxy server forwards transactions statefully until a pre-defined utilization threshold is reached for that server. As the call load continues to increase after the utilization threshold is reached, the proxy server routes the extra call load statelessly. In addition, the proxy server reduces the amount of state it maintains by small amounts when required, because the server needs to create utilization space to route the increasing call load statelessly.

If subsequent proxy servers disposed in series with the initial proxy server and located downstream thereof also employ this modified greedy strategy, a system of dynamically self configuring proxy servers in accordance with the present invention is obtained. Each downstream proxy server within the system maintains the state for requests that the upstream servers have handled statelessly. Thus, each proxy server within the system continually works to find an operating point where the number of transactions forwarded through that proxy server is maximized while ensuring that the total number of transactions that the entire system forwards is maximized. This two step approach of maximizing throughput at both the proxy server and system level allows each proxy server within the system to determine the optimal fraction of calls for which it maintains state locally. Proxy server level determination of the fraction of transactions to be forwarded statefully forms the basis of the dynamically stateful algorithm (DSA) of the present invention.

Exemplary embodiments of the dynamic server algorithm in accordance with the present invention include two parts. The first part is executed on receipt of each message that is part of a transaction, and the second part is carried out periodically. The first part is referred to as Algorithm 2, the message handling algorithm and is:

Increment rcv_msg_count
If state is not already maintained for msg AND (rcv_msg-count <
Csf_myshare
OR msg is part of existing transaction OR state is not droppable for msg )
then
| Forward msg statefully
else
| Forward msg statelessly
end

The second part is referred to as Algorithm 3, the algorithm to calculate Csf_myshare and is:

| | // Reset rcv_msg_count |
|---|---|
| | // Csf_myshare initialized to ∞, is_saturated to false |
| | // First time Csf_reduced = ∞ |
| 1 | Csf_req = min( ( C − Csf_up), Csf_myshare) |
| 2 | Measure CPU utilization, U |
| | // Check CPU utilization threshold |
| 3 | if U < V_high then |
| 4 | \| Csf_myshare = Csf_req |
| 5 | \| if is_saturated AND U < U_low then |
| 6 | \| \| is_saturated = false |
| 7 | \| \| Csf_reduced = ∞ |
| 7.5 | Send unthrottle messages upstream |
| 8 | \| end |
| 9 | else if there exists downstream servers AND |
| 10 | downstream servers are not saturated then |
| 11 | \| Csf_myshare = Csf_reduced = min( Csf_req, CsLreduced) − |
| | deltaC |
| 12 | else |
| 13 | \| is_saturated = true |
| 14 | \| Send throttle messages upstream |
| 15 | end |

The algorithm for calculating myshare (Algorithm 3) updates, after each periodic interval, the number of calls or transactions that the proxy server can route statefully. At the end of each interval, the algorithm calculates Csf_myshare, which determines this amount. The values for C and Csf_up are constantly updated based on the load distribution at the proxy server. The algorithm for handling messages (Algorithm 2) uses the value of Csf_myshare to determine whether or not more messages can be forwarded statefully.

In addition, a series of additional checks are also performed before a determination is made regarding how to forward a message. The first check in algorithm 2 ensures two different servers do not store state for the same transaction or dialog. In one embodiment, this check is facilitated by communicating state summaries among the plurality of proxy servers. The state summaries provide a listing or indication of the transactions/dialogs for which state is already maintained at one of the proxy servers within the system. For a dialog stateful server, whether state is already maintained is present in the Record-Route header of the SIP message. Each server that maintains dialog state for the call appends its IP address to this header. For transaction state, as opposed to dialog state, a similar header field does not exist. Therefore, a new header, called Tran-State, is created, and the server that maintains state sets the value of this header to 1. Thus downstream servers can extract information from the Via header or the Tran-State header and can determine if state is already maintained. If state has not been maintained previously, the proxy server determines whether or not it has exceeded the stateful limit set by Csf_myshare. If the limit is exceeded, the proxy server tries to forward this request statelessly.

The final proxy server that ends up maintaining state for a particular transaction depends on the ordering of transactions, as each proxy server tries maintaining state for transactions in a first come first serve (FCFS) manner. For calls that have lossy links anywhere in their path or for end point clients that aggressively retransmit, the FCFS mechanism is inappropriate when the state for these calls is stored at proxy servers at the edge of the system, i.e., a significant number of servers away from the client. This is because all intermediate proxy servers, by virtue of being stateless, will let the retransmission propagate to this edge proxy server. For such calls or clients, the system preferably stores transaction state close to the call origin or client endpoint to ensure that the retransmission gets absorbed quickly without congesting the network.

In the algorithm for handling messages (Algorithm 2), the check “state is not droppable for msg” executes the above described functionality. Realizing this check is not simple. If state was being maintained already at the proxy server, determining the identification of the message as a retransmission is trivial. However, if this proxy server has been stateless for this transaction or dialog, the message and the retransmission of that message are viewed as two separate messages. Therefore each proxy server needs to maintain minimal state. In one embodiment, maintenance of minimal state is accomplished by maintaining a bloom filter on a hash of header values of the SIP message. A description of bloom filters is found in B. H. Bloom, Space/Time Trade-Offs in Hash Coding with Allowable Errors, Communications of the ACM, archive Volume 13, Issue 7, (July 1970). Typically, most servers associate subsequent responses or requests to the first request by maintaining a hash of certain fields as specified in RFC 3261, J. Rosenberg, H. Schulzrinne, G. Camarillo, A. Johnston, J. Peterson, R. Sparks, M. Handley, and E. Schooler, SIP: Session initiation protocol, RFC 3261, June 2002. This hash value is also used for the bloom filter. When the bloom filter recognizes a message hash that is constantly recurring, the proxy server starts maintaining state preferentially for the client endpoint that is the originator of that message. This state is maintained for any new call that this endpoint tries to establish. Therefore, state is distributed in the system of servers in an intelligent way.

When a given proxy server and all paths downstream of that proxy server reach saturation, the proxy server sends a saturation report, also referred to as a throttle message, to proxy servers located upstream (Algorithm 2, line 14). Once the upstream server receives the throttle message, the upstream proxy server realizes that additional state cannot be delegated through that downstream path of servers. In one embodiment, the throttle message is only generated by a downstream proxy server when that proxy server and all proxy server paths downstream to it are saturated. In addition, proxy servers are able to indicate when a saturation condition no longer exists, either when the call load decreases or when addition capacity is found in the downstream paths. Communication of a non-saturation condition is accomplished using a saturation report that is referred to as an unthrottle message (Algorithm 2, line 7.5). The unthrottle message is similar to the throttle message, but with the throttle header turned off. Proxy servers make the determination regarding sending of throttle messages (on saturation) or unthrottle messages (out of saturation) by checking CPU utilization against a pre-determined threshold level U_high and U_low respectively, with U_low<U_high<1. The different thresholds are used to avoid hysteresis. The difference between a throttle message and its toggling off, i.e., an unthrottle message, is that a throttle message is only directed to an immediately upstream proxy server and an unthrottle message is relayed to all upstream proxy servers that can reach this path. Throttle messages follow the reverse path of communication but do not cause loops because these messages also have a strict sense of direction, which is the reverse of the direction of the call flow.

In general, systems and methods in accordance with the present invention determine an optimal ratio of stateful to stateless transaction. The algorithm utilized is a dynamic algorithm in that recomputes the ratio as the total input load changes. The per-server algorithm is leveraged to establish an optimal system-wide algorithm. The system of the present invention ensures that each request is handled statefully at some downstream server (“distributing state”) when upstream servers handle the requests statelessly. In accordance with the present invention, a given request needs a set of functions to be executed in its call path or before exiting a domain, some of which may require stateful processing. Therefore, these functions can be performed over a sequence of proxies.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for dynamic maintenance of state in a server network in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object-oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention and can be executed or performed in any suitable order. Therefore, it will be understood that the appended claims are intended to cover all such modifications and embodiments, which would come within the spirit and scope of the present invention.

What is claimed is:

1. A method for dynamic maintenance of state in a server network, the method comprising:
processing transactions through a network comprising a plurality of proxy servers by routing a plurality of messages through the network, each transaction comprising a plurality of messages;
optimizing the ratio of transactions processed statefully to transactions processed statelessly at each one of the plurality of proxy servers to maximize a total number of messages routed through the network; and
maintaining state for each one of the plurality of transactions at only one of the plurality of proxy servers in the network.

2. The method of claim 1, wherein the step of processing further comprises processing using session initiation protocol.

3. The method of claim 1, wherein the step of optimizing further comprises identifying at each one of the plurality of proxy servers a portion of the routed messages to be forwarded statefully.

4. The method of claim 3, wherein the step of identifying a portion of the routed messages further comprises forwarding routed messages statefully from each one of the plurality of proxy servers until a pre-defined resource utilization threshold is reached at each proxy server.

5. The method of claim 3, wherein the step of identifying at each one of the plurality of proxy servers a portion of the routed messages to be forwarded statefully further comprises:
communicating from an upstream proxy server to a downstream proxy server messages forwarded statefully by the upstream proxy server;
identifying a portion of the routed messages to be forwarded statefully by the downstream proxy server;
determining resource utilization by the downstream proxy server based on forwarding the identified portion of the routed messages statefully and a balance of the routed messages statelessly; and
comparing the determined resource utilization to a pre-defined utilization threshold for the downstream proxy server.

6. The method of claim 5, further comprising accepting the identified portion of the routed messages to be forwarded statefully based on the comparison of the determined resource utilization to the pre-defined utilization threshold.

7. The method of claim 5, further comprising decreasing the identified portion of the routed messages to be forwarded statefully based on the comparison of the determined resource utilization to the pre-defined utilization threshold.

8. The method of claim 7, further comprising decreasing the identified portion of the messages to be forwarded statefully further when the utilization threshold of the downstream server exceeds the pre-defined utilization threshold.

9. The method of claim 5, wherein the step of identifying a portion of the messages to be forwarded statefully by the downstream server further comprises selecting all routed messages not identified as having been forwarded statefully by the upstream proxy server.

10. The method of claim 1, further comprising reducing a number of messages forwarded statefully for at least one proxy server in order to create resource utilization capacity at that proxy server.

11. The method of claim 1, further comprising communicating saturation reports from downstream proxy servers to upstream proxy servers regarding the level of resource utilization saturation at the downstream proxy servers.

12. The method of claim 11, wherein the saturation reports comprise an indication that all downstream proxy servers are saturated.

13. The method of claim 1, further comprising communicating state summaries from upstream proxy servers to downstream proxy servers identifying routed messages that have been forwarded statefully.

14. The method of claim 1, further comprising balancing the portion of messages routed statefully at each proxy server.

15. The method of claim 1, wherein the step of optimizing further comprises identifying the messages to be forwarded statefully at each one of the plurality of proxy servers.

16. The method of claim 15, wherein the step of identifying messages to be forwarded statefully further comprises:
identifying at each proxy server if a given routed message has been forwarded statefully;
identifying at each proxy server if a current number of statefully forwarded messages exceeds a prescribed limit for that proxy server;
identifying at each proxy server if a given message is part of an existing transaction; and
identifying at each proxy server if a given message is a retransmission.

17. The method of claim 1, wherein the step of optimizing further comprises forwarding a sufficient number of messages statelessly at each proxy server to provide a sufficient number of messages to be forwarded statefully by downstream proxy servers.

18. A computer-readable medium containing a computer-readable code that when read by a computer causes the computer to perform a method for dynamic maintenance of state in a server network, the method comprising:
processing transactions through a network comprising a plurality of proxy servers by routing a plurality of messages through the network, each transaction comprising a plurality of messages;
optimizing the ratio of transactions processed statefully to transactions processed statelessly at each one of the plurality of proxy servers to maximize a total number of messages routed through the network; and
maintaining state for each one of the plurality of transactions at only one of the plurality of proxy servers in the network.

19. The computer readable medium of claim 18, wherein the step of processing further comprises processing using session initiation protocol.

20. The computer readable medium of claim 18, wherein the step of optimizing further comprises identifying at each one of the plurality of proxy servers a portion of the routed messages to be forwarded statefully by:
communicating from an upstream proxy server to a downstream proxy server messages forwarded statefully by the upstream proxy server;
identifying a portion of the routed messages to be forwarded statefully by the downstream proxy server;
determining resource utilization by the downstream proxy server based on forwarding the identified portion of the routed messages statefully and a balance of the routed messages statelessly; and
comparing the determine resource utilization to a pre-defined utilization threshold for the downstream proxy server.
